(19) United States
(12) Patent Application Publication
(10) Pub. No.: US 2017/0028766 A1
(43) Pub. Date: Feb. 2, 2017

(54) Checkpress

(71) Applicant: Raymond Avedian, Los Angeles, CA (US)

(72) Inventor: Raymond Avedian, Los Angeles, CA (US)

(21) Appl. No.: 15/221,840

(22) Filed: Jul. 28, 2016

Related U.S. Application Data
(60) Provisional application No. 62/198,942, filed on Jul. 30, 2015.

(51) Int. Cl. B42F 5/00; F21V 33/00; F16B 2/10; F16B 1/00; F16B 2/06

(52) U.S. Cl. CPC B42F 5/00; F16B 1/00; F16B 2/06; F16B 2/10; F21V 33/0004; F16B 2001/0035; G06K 7/10366

(57) ABSTRACT

A flattening device for bank checks and other small documents, made of two transparent sheets of material that are rotatable at a common hinge point and attracted together with sufficient force to flatten creased or crumpled checks inserted between them to allow for easier viewing and photographing.

### BACKGROUND AND SUMMARY

With the creation of banking apps, people can now deposit checks from home by taking a picture of the check with their phones. However, the deposit may not be successful if the check is not sufficiently flat or does not have an appropriately dark background and hence does not photograph well. My invention is a device that allows the user to sandwich the check between two pieces of non-glare acrylic and then lay it on a black felt bag, simultaneously flattening it and providing a dark background that will ensure a photograph that will be usable by the banking app.

### THE DRAWINGS

FIG. 1 is an exploded view showing the separate parts of the checkpress in spaced apart relation.

FIG. 2 is a front elevational view of a checkpress

FIG. 3 is a front elevational view of a storage/carrying bag for the checkpress that can also be used as a dark background for picture taking purposes.

### DETAILED DESCRIPTION

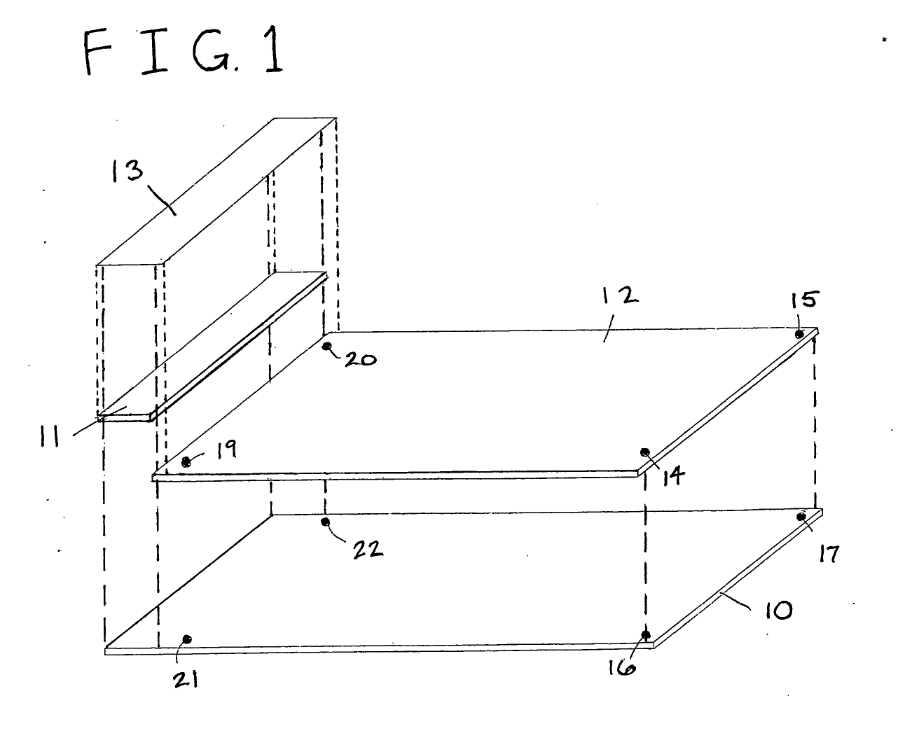

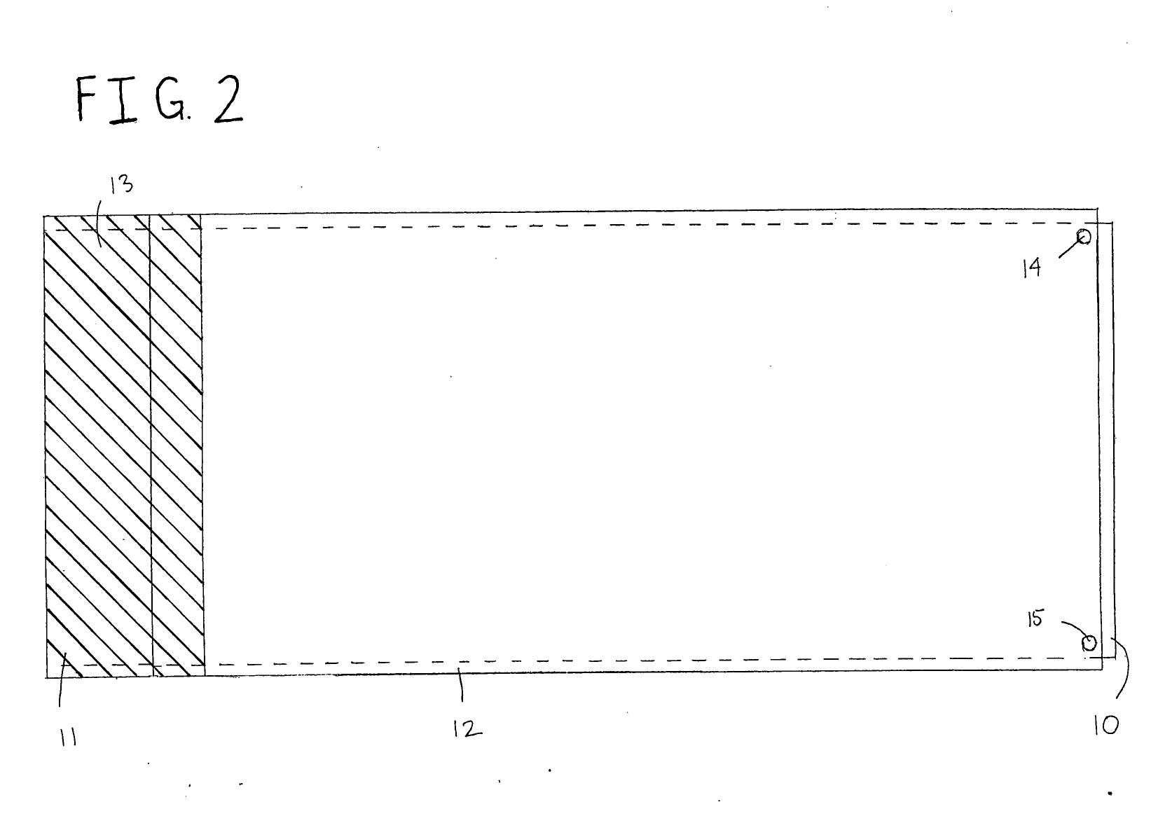

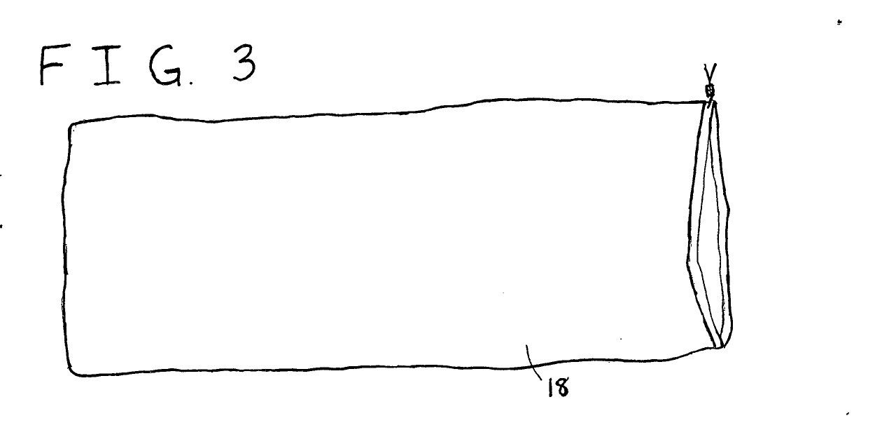

FIG. 1 shows one form the checkpress can take. A small, black rectangular end piece of plastic 11 such as acrylic is attached by means of glue or other adhesive to a longer rectangular base of clear, non-glare plastic 10 at one end. Another rectangular piece of clear, non-glare plastic 12 is laid on top of the base piece 10 and flush against the black end piece 11. The outer end of the top piece 12 is held securely against the base 10 by the small magnets 14-17 embedded in the corners of both pieces. The entire device is stored in a bag 18 depicted in FIG. 3, which is constructed of a dark material. The bag 18 will double as a background for photographs, hence its dark coloring. Color choices for the bag 18 include, but are not limited to, black, navy blue, brown, gray, or dark red. With the tape 13 acting as a hinge, the top piece 12 can rotate away from the base piece. As is shown in FIG. 2, the top piece 12 is of sufficient length to be slightly shorter than the base piece 10 so that a user can use a finger or thumb to hold the base 10 in place while rotating the top piece 12 up and away from it. With similar logic, top piece 12 is slightly wider than the base 10 so that a user can grasp it alone without simultaneously grabbing the base 10.

By opening and closing the top piece 12 and base 10 a check can be inserted between them. The attraction of the magnets will hold the two pieces 10, 12 tightly together, completely flattening the check.

Other embodiments are possible through slight modifications of the components, while keeping the functionality of the unit the same. These include the following:
1. The base piece 10, the end piece 11, and the top piece 12 can be shapes other than rectangular as long as there is sufficient space between the pieces to completely sandwich a check and as long as there is sufficient overlap to allow users to easily grasp the separate pieces and pry them apart.
2. The adhesive 13 can be replaced with actual hinges that hold the end piece 11 and the top 12 together and allow for rotation.
3. The magnets 14-17 can be replaced with a small plastic peg-and-hole system that will serve the same function. They can also be replaced by a clasp on the ends of the top piece 12 and base piece 10.
4. The base piece 10 can be made of a dark, opaque material, obviating the need for a separate or external dark background.
5. Four extra magnets 19-22 can be used to provide a stronger attraction between the top piece 12 and the base 10 to better ensure that the enclosed check is flattened completely.
6. An RFID chip can be inserted into the endpiece 11 that can be synched with the banking app on the user's phone to facilitate use of the app.
7. The end piece 11 may have a company's logo engraved or otherwise depicted in it.
8. Materials other than plastic may be used for the different pieces. For example, all three pieces 10-12 may be made of glass. The end piece 11 may be made of metal or wood. The base piece 12 may likewise be made of metal or wood if the above modification 4 is employed.
9. For each pair of joining magnets, one of the magnets can be replaced with a similar sized disc of magnetic material, such as—but not limited to—iron or steel, while retaining functionality.
10. An LED light can be inserted into the endpiece 11 that can be used to provide lighting for the camera on the user's phone.

What is claimed is:

1. A checkpress, comprising:
a base made of a clear material with small embedded magnets at two adjacent corners of its short end;
an end piece, fixed to the end of said base opposite the magnets and supported by said base;
a top piece made of clear material and supported by said base and laid flush against said end piece; and
wherein said top piece is rotatably connected to said end piece by means of adhesive tape to enable a check to be sandwiched between said base and said top piece.

2. The checkpress of claim 1, wherein said adhesive tape is replaced by hinges.

3. The checkpress of claim 1, wherein said top piece has an extra pair of embedded magnets in the corners adjacent to said end piece, and wherein said base has an extra pair of embedded magnets located directly under the extra pair of magnets in said top piece.

4. The checkpress of claim 3, wherein said embedded magnets in the said top piece are replaced by pegs and said embedded magnets in said base are replaced by holes for said pegs.

5. The checkpress of claim 1, wherein said base is made of a dark, opaque material.

6. The checkpress of claim 1, wherein said end piece contains an RFID chip that can be synched with cellular phone banking apps.

7. The checkpress of claim 1, wherein an LED light can be inserted into said endpiece to provide lighting for picture taking.
